(19) United States
(12) Patent Application Publication
(10) Pub. No.: US 2020/0400112 A1
(43) Pub. Date: Dec. 24, 2020

(54) Fuel Injection Valve

(71) Applicant: Hitachi Automotive Systems, Ltd., Hitachinaka-shi, Ibaraki (JP)

(72) Inventors: Hiroshi MUKAI, Tokyo (JP); Mitsuhiro MATSUZAWA, Tokyo (JP); Akihiro YAMAZAKI, Hitachinaka-shi (JP); Masaki NAGAOKA, Hitachinaka-shi (JP); Takahiro SAITO, Hitachinaka-shi (JP); Eiji ISHII, Tokyo (JP); Taisuke SUGII, Tokyo (JP); Kazuki YOSHIMURA, Tokyo (JP)

(21) Appl. No.: 16/956,838

(22) PCT Filed: Sep. 25, 2018
(86) PCT No.: PCT/JP2018/035389

§ 371 Date: Jun. 22, 2020

(30) Foreign Application Priority Data
Feb. 23, 2018 (JP) 2018-030553

(51) Int. Cl. F02M 61/18; F02M 61/16

(52) U.S. Cl. CPC F02M 61/1853; F02M 51/0671; F02M 61/162

(57) ABSTRACT

An object of the present invention is to provide a fuel injection valve that realizes atomization while suppressing spread of a spray. A fuel injection valve includes: a valve body and a valve seat that cooperate to open and close a fuel passage; a swirl imparting chamber that is arranged on a downstream side of an opening and closing portion of the fuel passage by the valve body and the valve seat, and imparts a swirling velocity to fuel; a communication passage arranged on an upstream side of the swirl imparting chamber and connected to the swirl imparting chamber; and fuel injection holes and that are open at a bottom surface of the swirl imparting chamber and injects fuel imparted with the swirling velocity in a swirl passage to an outside, the fuel injection holes and configured such that cross-sectional areas of the fuel injection holes and increase from the inlet to the outlet.

### TECHNICAL FIELD

The present invention relates to a fuel injection valve that is used to control fuel supply to an engine and injects fuel.

### BACKGROUND ART

In recent years, exhaust gas regulations for automobiles have been tightened. In response to the tightening of exhaust gas regulations, atomization and an accurate injection direction are required for a spray of fuel injection valves mounted on internal combustion engines for automobiles. The atomization of the spray can achieve reduction in fuel consumption of an automobile engine. Further, in a fuel injection valve that injects fuel into an intake manifold, it is possible to suppress adhesion of a spray to a wall surface of the intake manifold by injecting the spray to a target position. Incidentally, a mode in which a spray is injected in a direction toward an intake valve with the intake valve as a target position is often used. Further, a mode in which two intake valves are provided for one cylinder is often used, and in this case, a spray injected from a fuel injection valve includes two sprays directed to the two intake valves (sprays directed in two directions).

For example, JP 2003-336562 A (PTL 1) discloses a fuel injection valve that can effectively promote atomization of fuel after injection. The fuel injection valve of PTL 1 includes: a valve seat member; a lateral passage communicating with a downstream side of a valve seat between the valve seat member and an injector plate joined to a front end surface of the valve seat member; and a swirl chamber in which a downstream end of the lateral passage is open in a tangential direction. In the fuel injection valve having a fuel injection hole that injects fuel imparted with swirl in the swirl chamber (hereinafter referred to as the injection hole) formed in the injector plate, the injection hole is arranged to be offset from a center of the swirl chamber by a predetermined distance toward an upstream end side of the lateral passage (see Abstract).

For example, JP 2013-185522 A (PTL 2) discloses an idea in which an injection hole is formed in an elliptical shape, a thickness of a liquid film in the injection hole is controlled to manipulate a spray shape (see paragraphs 0015 to 0019).

### CITATION LIST

### Patent Literature

PTL 1: JP 2003-336562 A

PTL 2: JP 2013-185522 A

### SUMMARY OF INVENTION

### Technical Problem

In PTL 1, consideration is given to an increase of a swirl force of fuel by increasing a swirling velocity of the fuel in order to promote fuel atomization. There is an effect that atomization of fuel injected from the injection hole is promoted by the strong swirling force. On the other hand, there is a problem that a spray angle becomes large due to wide spread of a spray immediately below the injection hole caused by the strong swirling force. That is, there is a possibility that the spray may adhere to a wall surface of an intake manifold if the spray widely spreads immediately below the injection hole. Further, when a plurality of injection holes are formed in one nozzle plate, sprays that have been injected from the respective injection holes with large spray angles overlap each other, and it is difficult to form sprays in a plurality of directions from one nozzle plate.

In PTL 2, a spray is switched in a specific direction by flattening the spray using the elliptical injection hole, but a spray angle increases depending on a direction because the spray has a shape obtained by crushing a cone from the side, and a risk that the spray adheres to the wall surface is likely to increase.

In general, there is a trade-off relation between atomization and narrowing. If the swirl force flowing into the injection hole is strengthened, the atomization is promoted, but the spray angle widens. Conversely, if the swirl force is weakened, the spray angle narrows, but a particle diameter tends to increase because separation generated at an inflow portion of the injection hole remains even at an outlet of the injection hole in some cases.

An object of the present invention is to provide a fuel injection valve that realizes atomization while suppressing spread of a spray.

### Solution to Problem

In a fuel injection valve provided with a swirl chamber, which imparts a swirling velocity around a central axis of an injection hole to a fluid flowing into the injection hole, on an upstream side of the injection hole, a cross-sectional area of the injection hole increases from an inlet to an outlet of the injection hole.

### Advantageous Effects of Invention

Since the cross-sectional area of the injection hole is increased from the inlet to the outlet, a length of a path in which the swirling fuel flowing in the injection hole flows down in contact with a wall surface of the injection hole increases, and the swirling velocity is reduced by increasing a friction loss of the swirl fuel. As a result, a spray angle decreases. On the other hand, a thickness of a liquid film formed by the swirling fuel decreases from the inlet to the outlet as a radius of the injection hole increases from the inlet to the outlet. As a result, the spray is atomized. Other objects, configurations, and effects which have not been described above become apparent from embodiments to be described hereinafter.

### BRIEF DESCRIPTION OF DRAWINGS

FIG. 1 is a cross-sectional view taken along a direction of an axis 1x of a fuel injection valve 1 according to an embodiment of the present invention.

FIG. 2 is an enlarged cross-sectional view of the vicinity of a nozzle plate 8 of the fuel injection valve 1 of FIG. 1.

FIG. 3 is a plan view of the nozzle plate 8 of the fuel injection valve 1 of FIG. 1 as viewed from one end side (upstream side) in the direction of the axis 1x.

FIG. 4 is a view schematically illustrating a state of fuel in the fuel injection hole 1.

FIG. 5 is a view schematically illustrating a state of fuel in the fuel injection hole 1 when the fuel injection hole 1 is inclined.

FIG. 6 is an enlarged cross-sectional view of the vicinity of the nozzle plate 8 of the fuel injection valve 1.

FIG. 7 is a plan view of the nozzle plate 8 as viewed from one end side (upstream side) in the axial direction.

FIG. 8 is an enlarged plan view illustrating the vicinity of a swirl imparting chamber 46 including a connection portion between a communication passage 45 and the swirl imparting chamber 46.

FIG. 9 is a cross-sectional view illustrating a cross section parallel to an axis 44x of the fuel injection hole 44 and including the axis 44x.

FIG. 10 is a view illustrating a modification of the nozzle plate 8 of the fuel injection valve 1, and is a plan view as viewed from one end side (upstream side) in the direction of the axis 1x.

### DESCRIPTION OF EMBODIMENTS

Hereinafter, embodiments of the fuel injection valve according to the present invention will be described.

### First Embodiment

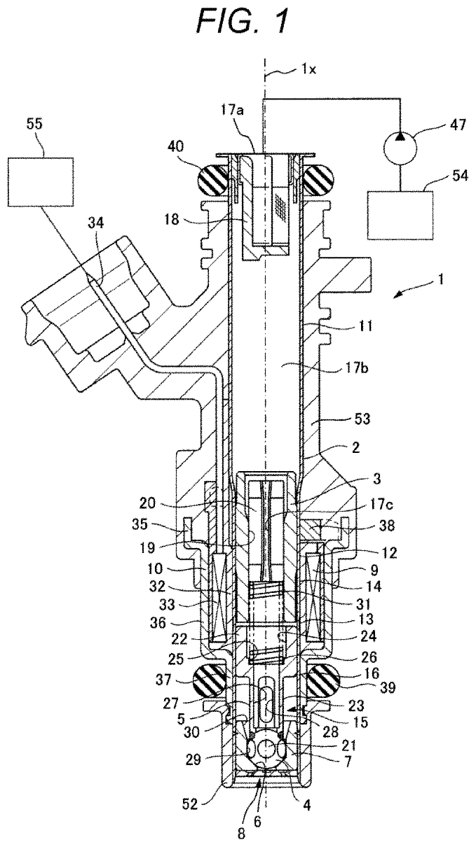

FIG. 1 is a cross-sectional view taken along a direction of an axis 1x of a fuel injection valve 1 according to an embodiment of the present invention. The axis (valve axis) 1x of the fuel injection valve 1 is an axis passing through a center of the fuel injection valve 1, and an axis of a valve member 15 is arranged so as to coincide with the axis 1x. Further, a magnetic cylinder 2 and a valve seat member 7 are arranged such that center lines coincide with the axis 1x.

In FIG. 1, an upper end and a lower end of the fuel injection valve 1 are sometimes referred to as a proximal end and a distal end, respectively. The terms “proximal end” and “distal end” are based on a flow direction of fuel or an attachment structure of the fuel injection valve 1 with respect to a fuel pipe. Further, the vertical relation described in the present specification is based on FIG. 1, and does not relate to the vertical direction in a mounting state where the fuel injection valve 1 is mounted on an internal combustion engine.

The fuel injection valve 1 is used for an automobile gasoline engine, and is a low-pressure fuel injection valve that injects fuel from an intake manifold toward an intake valve.

The fuel injection valve 1 includes: the magnetic cylinder 2; a core cylinder 3 accommodated in the magnetic cylinder 2; a valve body 4 slidable in the axial direction; a valve shaft 5 integrated with the valve body 4; a valve seat member 7 having a valve seat 6 closed by the valve body 4 when the valve is closed; a nozzle plate 8 fixed to a distal end surface of the valve seat member 7; an electromagnetic coil 9 generating magnetic flux lines that move the valve body 4 in a valve opening direction when energized; and a yoke 10 inducing magnetic flux lines.

The magnetic cylinder 2 is made of a metal pipe or the like formed using a magnetic metal material such as an electromagnetic stainless steel, for example, and is integrally formed in a stepped cylindrical shape as illustrated in FIG. 1 using means of press working such as deep-drawing, grinding, or the like. The magnetic cylinder 2 has a large diameter portion 11 formed on one end side (proximal end side) and a small diameter portion 12 having a smaller diameter than the large diameter portion 11 and formed at the other end side (distal end side).

The small diameter portion 12 has a thin-walled portion 13 that is partially thinned. The small diameter portion 12 is divided into a core cylinder accommodating portion 14 that accommodates the core cylinder 3 on one end side of the thin-walled portion 13 and a valve member accommodating portion 16 that accommodates the valve member 15 (the valve body 4, the valve shaft 5, and the valve seat member 7) on the other end side of the thin-walled portion 13. Incidentally, the valve body 4 and the valve shaft 5 constitute a movable element driven with respect to the valve seat member 7 by magnetic flux lines generated by the electromagnetic coil 9.

The thin-walled portion 13 is formed so as to surround a gap portion between the core cylinder 3 and the valve shaft 5 in a state where the core cylinder 3 and the valve shaft 5 are accommodated in the magnetic cylinder 2 which will be described below. The thin-walled portion 13 increases a magnetic resistance between the core cylinder accommodating portion 14 and the valve member accommodating portion 16 so as to make a magnetic interruption between the core cylinder accommodating portion 14 and the valve member accommodating portion 16.

One end portion (proximal end portion) of the large diameter portion 11 is provided with a fuel supply port 17a. An inner diameter of the large diameter portion 11 constitutes a fuel passage 17b that sends fuel to the valve member 15, and a fuel filter 18 filtering the fuel is provided at the fuel supply port 17a provided in one end portion of the large diameter portion 11. A pump 47 is connected to the fuel supply port 17a. The pump 47 is controlled by a pump control device 54. The fuel flows from the proximal end portion to a distal end portion of the fuel injection valve 1 through the fuel passage 17b. Therefore, the proximal end portion of the fuel injection valve 1 is an upstream end portion of the fuel passage formed in the fuel injection valve 1, and the distal end portion is a downstream end portion.

The core cylinder 3 is formed in a cylindrical shape having a hollow portion 19, and is pressed into the core cylinder accommodating portion 14 of the magnetic cylinder 2. The core cylinder 3 is also sometimes referred to as a fixed core. The hollow portion 19 accommodates a spring bearing 20 fixed by means such as press-fitting. A fuel passage 17c penetrating in the axial direction is formed at the center of the spring bearing 20.

An outer shape of the valve body 4 is formed in a substantially spherical shape, and has a fuel passage surface cut in parallel to the axial direction of the fuel injection valve 1 on its circumference. The valve shaft 5 has a large diameter portion 22 and a small diameter portion 23 whose outer shape is formed to have a smaller diameter than the large diameter portion 22. The valve body 4 is integrally fixed to a distal end of the small diameter portion 23 by welding. The large diameter portion 22 constitutes a movable core (anchor) opposing the fixed core 3. Further, the small diameter portion 23 constitutes a shaft portion that connects and integrates the movable core 22 and the valve body 4. Incidentally, a black semicircle and a black triangle in the drawing indicate welding points.

A spring insertion hole 24 is formed in an end portion of the large diameter portion 22. At a bottom of the spring insertion hole 24, a spring seat portion 25 formed to have a smaller diameter than the spring insertion hole 24 is formed, and a stepped spring receiving portion (spring seat) 26 is formed. A fuel passage hole 27 is formed on an inner circumference of the small diameter portion 23. The fuel passage hole 27 communicates with the spring insertion hole 24. An outer circumference of the small diameter portion 23 and the fuel passage hole 27 communicate with each other by a fuel outflow hole 28 penetrating through a cylindrical portion constituting the small diameter portion 23.

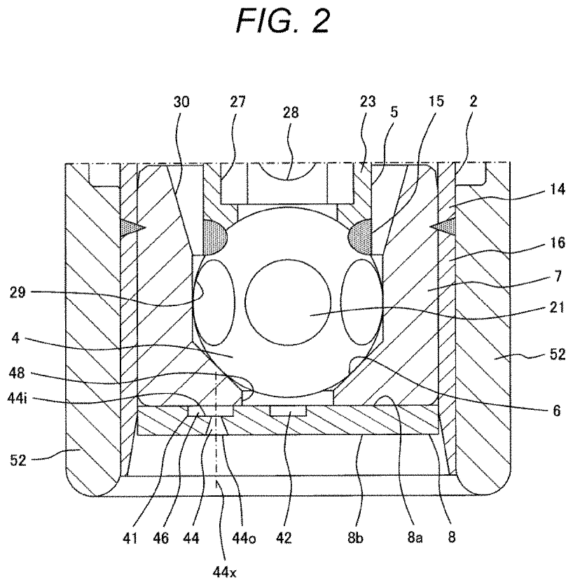

The valve seat member 7 includes: a substantially conical valve seat 6; a valve body holding hole 29 formed on one end side of the valve seat 6 in a shape having substantially the same diameter as a diameter of the valve body 4; an upstream opening portion 30 formed to have a larger diameter as proceeding from the valve body holding hole 29 toward one end opening side; and a downstream opening portion (see FIG. 2) that is open to the other end side of the valve seat 6.

The valve shaft 5 and the valve body 4 are installed in the magnetic cylinder 2 so as to be slidable in the axial direction. A coil spring 31 is provided between the spring receiving portion 26 and the spring bearing 20 of the valve shaft 5, and biases the valve shaft 5 and the valve body 4 to the other end side. The valve seat member 7 is inserted into the magnetic cylinder 2 and is fixed to the magnetic cylinder 2 by welding. The valve seat 6 is formed so as to decrease in diameter from the valve body holding hole 29 toward the downstream opening portion 48, and the valve body 4 is seated on the valve seat 6 when the valve is closed. When the valve body 4 moves toward and away from the valve seat 6, the valve body 4 and the valve seat 6 cooperate to open and close the fuel passage. An opening/closing portion (sealing portion) of the fuel passage is formed at a position where the valve body 4 and the valve seat 6 come into contact with each other.

The electromagnetic coil 9 is inserted around an outer circumference of the core cylinder 3 of the magnetic cylinder 2. That is, the electromagnetic coil 9 is arranged on the outer circumference (radially outer side) of the core cylinder 3. The electromagnetic coil 9 includes a bobbin 32 formed using a resin material, and a coil 33 wound around the bobbin 32. The coil 33 is connected to an electromagnetic coil control device 55 via a connector pin 34.

The electromagnetic coil control device 55 energizes the coil 33 of the electromagnetic coil 9 to open the fuel injection valve 1 according to the timing of injecting fuel into a combustion chamber side calculated based on information from a crank angle sensor that detects a crank angle.

The yoke 10 has a through-hole penetrating in a direction along the axis 1x, and is constituted by a large diameter portion 35 formed on one end opening side (proximal end side), a medium diameter portion 36 formed to have a smaller diameter than the large diameter portion 35, and a small diameter portion 37 formed on the other end opening side (distal end side) with a smaller diameter than the medium diameter portion 36. The small diameter portion 37 is fitted on an outer circumference of the valve member accommodating portion 16. The electromagnetic coil 9 is installed on an inner circumference of the medium diameter portion 36. A connecting core 38 is arranged on an inner circumference of the large diameter portion 35.

The connecting core 38 is formed in a substantially C shape using a magnetic metal material or the like. The yoke is connected to the magnetic cylinder 2 via the small diameter portion 37 and the connecting core 38. That is, the yoke 10 is magnetically connected to the magnetic cylinder 2 at both end portions of the electromagnetic coil 9 in the direction of the axis 1x. An O-ring 39 configured to connect the fuel injection valve 1 to an intake port of an engine is held on an outer circumference of the yoke 10 on the other end opening side (distal end side), and a protector 52 configured to protect a distal end of the magnetic cylinder 2 is attached to a distal end of the O-ring 39.

When power is supplied to the electromagnetic coil 9 via the connector pin 34, a magnetic field is generated, and a magnetic force of the magnetic field causes the valve body 4 and the valve shaft 5 to open the valve against a biasing force of the coil spring 31.

Most of the fuel injection valve 1 is covered with a resin cover 53. Portions covered by the resin cover 53 include: a portion from a portion of the magnetic cylinder 2 excluding one end portion (proximal end portion) of the large diameter portion 11 to a position where the electromagnetic coil 9 of the small diameter portion 12 is installed; a portion between the electromagnetic coil 9 and the medium diameter portion 36 of the yoke 10; a portion between an outer circumference of the connecting core 38 and the large diameter portion 35; an outer circumferential portion of the large diameter portion 35; an outer circumferential portion of the medium diameter portion 36; and an outer circumferential portion of the connector pin 34. One end portion (proximal end side end portion) of the connector pin 34 is exposed at an opening portion of the resin cover 53, and allows a connector of a control unit to be inserted therein. An O-ring 40 is provided on an outer circumference of one end portion of the magnetic cylinder 2.

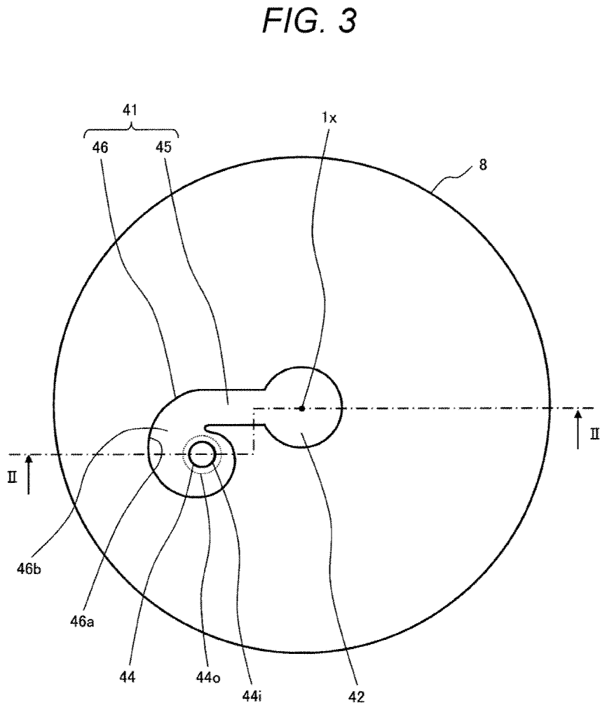

A configuration of the nozzle plate 8 will be described with reference to FIGS. 2 and 3. FIG. 2 is an enlarged cross-sectional view of the vicinity of the nozzle plate 8 of the fuel injection valve 1. FIG. 3 is a plan view of the nozzle plate 8 as viewed from one end side (upstream side) in the direction of the axis 1x. Incidentally, a cross section of the nozzle plate 8 in FIG. 2 is a cross section taken along line II-II illustrated in FIG. 3, and this cross section is a cross section parallel to the axis 1x of the fuel injection valve 1.

The nozzle plate 8 is welded to the other end side (distal end side) of the valve seat member 7. In the present embodiment, the nozzle plate 8 is arranged such that its center is located on the axis 1x of the fuel injection valve 1.

The nozzle plate 8 includes: a swirl passage 41 that imparts swirl (swirl flow) to fuel; a central chamber 42 that supplies fuel to the swirl passage 41; and a fuel injection hole 44 through which the fuel imparted with the swirl (swirling velocity) in the swirl passage 41 is injected.

The swirl passage 41 and the central chamber 42 are formed on one end surface (proximal end surface) 8a of the nozzle plate 8. The swirl passage 41 is constituted by a communication passage (lateral passage) 45 and a swirl imparting chamber (swirl chamber) 46. The central chamber 42 is formed in the center of the nozzle plate, and the communication passage 45 is connected to the central chamber 42. The swirl imparting chamber 46 is formed at a tip (downstream) of the communication passage 45, and the communication passage 45 is connected in a tangential direction of the swirl imparting chamber 46. The swirl imparting chamber 46 is formed in a bottomed concave shape having a spiral inner side surface (swirl imparting chamber side wall) 46a and a flat bottom 46b, and the fuel injection hole 44 formed as the through-hole penetrating through the other end surface (distal end surface) 8b is formed in the bottom 46b.

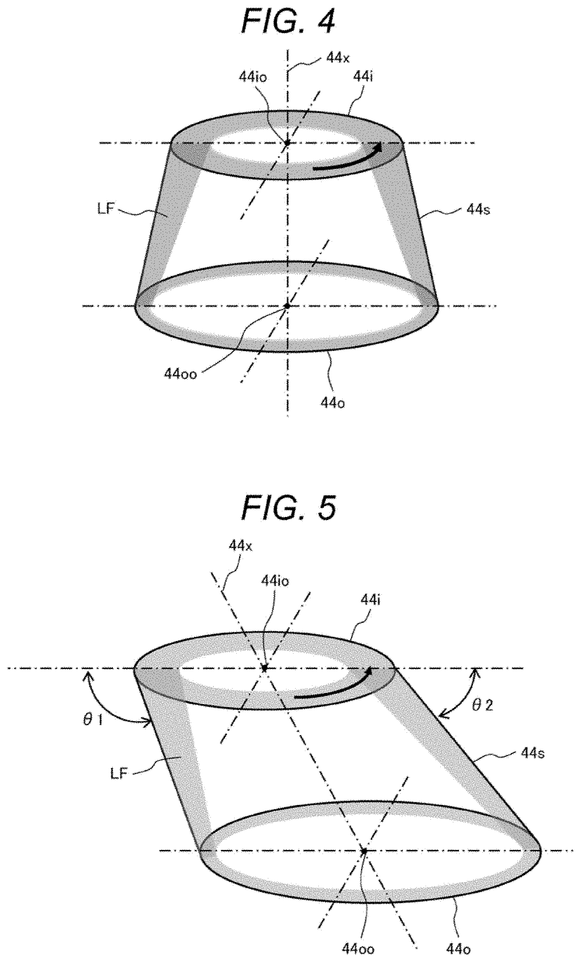

The fuel injection hole 44 is formed in a truncated cone shape (see FIG. 4) and is formed such that a cross-sectional area of the fuel injection hole 44 increases from an injection hole inlet 44i to an injection hole outlet (outlet opening surface) 44o. For this reason, the fuel injection hole 44 is formed such that the cross-sectional area of the injection hole outlet (outlet opening surface) 44o is larger than the cross-sectional area of the injection hole inlet (inlet opening surface) 44i. Here, the cross-sectional area of each of the injection hole inlet 44i and the injection hole outlet 44o is a cross-sectional area perpendicular to an axis (center line or hole axis) 44x of the fuel injection hole 44. Since, the axis 44x is perpendicular to the bottom (bottom surface) 46b of the swirl imparting chamber 46 and the distal end surface 8b of the nozzle plate 8 in the present embodiment, the cross-sectional area of the injection hole inlet 44i is equal to an area of an opening surface of the bottom surface 44b, and the cross-sectional area of the injection hole outlet 44o is equal to an area of an opening surface of the fuel injection hole 44 at the distal end surface 8b.

In the present embodiment, the axis 44x of the fuel injection hole 44 is arranged in parallel to the axis 1x of the fuel injection valve 1 on the same plane. The fuel injection hole 44 has a circular cross section from the injection hole inlet 44i (upstream end) to the injection hole outlet 44o (downstream end) and has the cross-sectional area monotonically increasing from the injection hole inlet 44i to the injection hole outlet 44o. That is, the fuel injection hole 44 has a shape whose diameter increases from the upstream side to the downstream side. In other words, the fuel injection hole 44 has an inner peripheral surface formed by a part (side surface of the truncated cone) 44s (see FIG. 4) on a bottom surface side of a conical surface (side surface) of a right cone.

Next, the flow of fuel in the fuel injection hole 44 will be described with reference to FIGS. 4 and 5. FIG. 4 is a view schematically illustrating a state of the fuel in the fuel injection hole 44.

The fuel in the fuel injection hole 44 flows toward the injection hole outlet 44o while swirling, but a distance in contact with the wall surface is extended since the radius of the injection hole outlet 44o side increases with respect to the injection hole inlet 44i, and swirling energy is deprived accordingly. As a result, the swirling velocity decreases, and a spray angle of the fuel injected from the fuel injection hole 44 decreases (is narrowed). At the same time, a ratio of a surface area of the inner peripheral surface 44s of the fuel injection hole 44 relative to a length in the direction of the axis 44x increases from the upstream side to the downstream side, and thus, the fuel spreads so that a thickness of a liquid film LF decreases. As a result, atomization is promoted.

The axis 44x of the fuel injection hole 44 may be inclined with respect to the axis 1x instead of being 90 degrees (perpendicular) to the bottom (bottom surface) 46b of the swirl imparting chamber 46 and the distal end surface 8b of the nozzle plate 8. That is, an angle larger than 0° is provided between the axis 44x and the axis 1x. FIG. 5 is a view schematically illustrating a state of fuel when the fuel injection hole is inclined.

Even in the case of FIG. 5 (oblique cone), the decrease in the swirling velocity and the decrease in the thickness of the liquid film promote the narrowing and atomization of the spray similarly to the case of FIG. 4 (right cone).

Although the single swirl passage 41 is provided in the present embodiment, a plurality of the swirl passages 41 may be provided. In this case, the plurality of swirl passages 41 are connected to the central chamber 42, and fuel is distributed from the central chamber 42 to each of the swirl passages 41.

### Second Embodiment

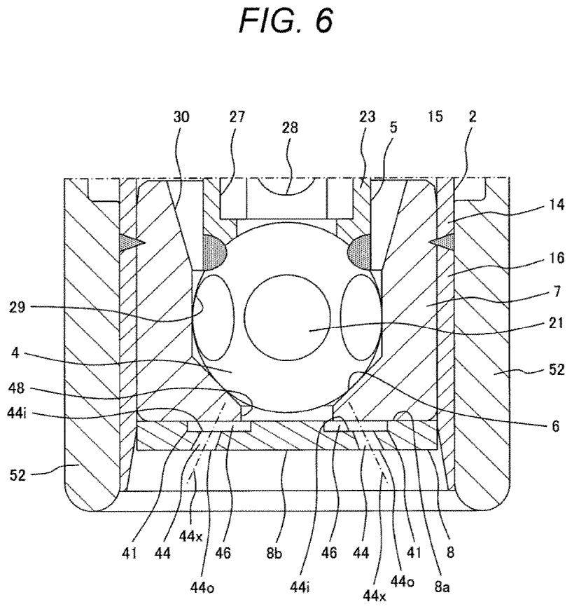

Next, a second embodiment according to the present invention will be described with reference to FIGS. 6 to 9.

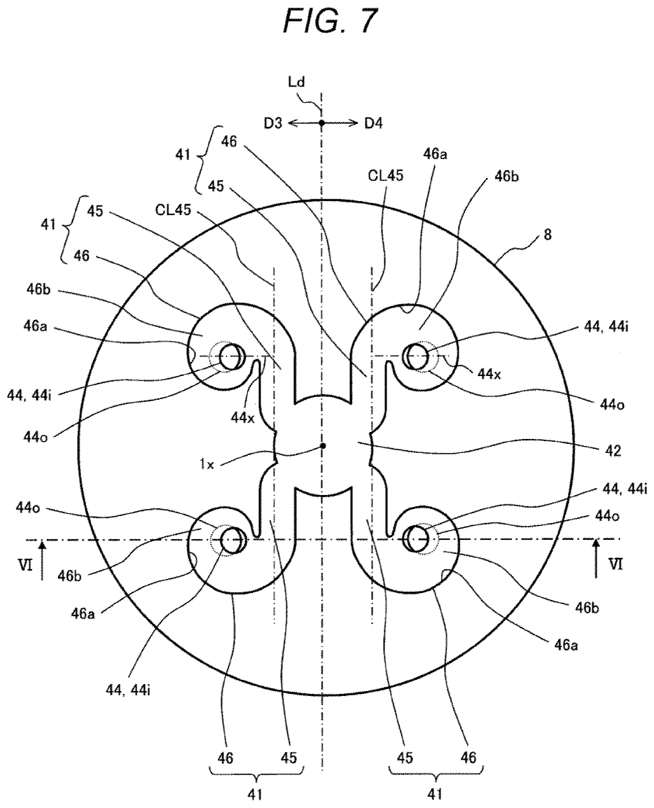

FIG. 6 is an enlarged cross-sectional view of the vicinity of the nozzle plate 8 of the fuel injection valve 1. Incidentally, a cross section of the nozzle plate 8 in FIG. 6 illustrates a cross section taken along line VI-VI illustrated in FIG. 7. That is, FIG. 6 is the cross section parallel to the axis 1x of the fuel injection valve 1. The same configurations as those in the first embodiment will be denoted by the same reference signs, and the description thereof will be partially omitted.

On the one end surface 8a of the nozzle plate 8, a plurality of swirl passages 41 and one central chamber 42 are formed. The present embodiment is different from the first embodiment in terms of a configuration in which the plurality of swirl passages 41 are connected to the central chamber 42 (see FIG. 7). A configuration of each of the swirl passages 41 is the same as that of the first embodiment. Incidentally, the axis 44x of the fuel injection hole 44 is configured to be inclined with respect to the axis 1x in the present embodiment. That is, an angle larger than 0° is provided between the axis 44x and the axis 1x.

Each of the fuel injection holes 44 is formed in a truncated cone shape obtained from an oblique cone. In the present embodiment, the fuel injection hole 44 has a shape whose cross section, parallel to the bottom (bottom surface) 46b of the swirl imparting chamber 46 and the distal end surface 8b of the nozzle plate 8 is circular from the injection hole inlet 44i (upstream end) to the injection hole outlet 44o (downstream end), and has a cross-sectional area monotonically increasing from the injection hole inlet 44i to the injection hole outlet 44o. That is, the fuel injection hole 44 has a shape whose diameter increases from the upstream side to the downstream side. In other words, the fuel injection hole 44 has an inner peripheral surface formed by a part (side surface of the truncated cone) on a bottom surface side of a surface (side surface) of the oblique cone.

Incidentally, the right cone is a special form of the oblique cone, and the oblique cone or simply a cone are referred including the right cone. Therefore, the truncated cone is configured using a part on the bottom surface side of the oblique cone including the right cone (FIG. 5). The fuel injection hole 44 in the present embodiment has the inner peripheral surface formed by a part (side surface of the truncated cone) 44s (see FIG. 5) on the bottom surface side of the conical surface (side surface) of the oblique cone.

Incidentally, the fuel injection hole 44 may have a circular cross section perpendicular to the axis 44x, and have a cross-sectional area monotonically increasing from the injection hole inlet 44i to the injection hole outlet 44o.

FIG. 7 is a plan view of the nozzle plate 8 as viewed from one end side (upstream side) in the axial direction. The proximal end surface 8a and the distal end surface 8b of the nozzle plate 8 are perpendicular to the axis 1x of the fuel injection valve 1, and FIG. 7 is a projection view in which the central chamber 42, the fuel injection holes 44, the communication passage 45, and the swirl imparting chamber 46 are projected on a plane perpendicular to the axis 1x. Incidentally, the solid line indicates a configuration that appears on the proximal end surface 8a of the nozzle plate 8.

Hereinafter, a description will be given based on the projection view of FIG. 7.

In the present embodiment, four swirl passages 41 (four sets) are provided on the nozzle plate 8, and each of the swirl passages 41 has an upstream end portion of the communication passage 45 connected to the central chamber 42. Each of the swirl passages 41 is provided on the nozzle plate 8 in the same form as in the first embodiment.

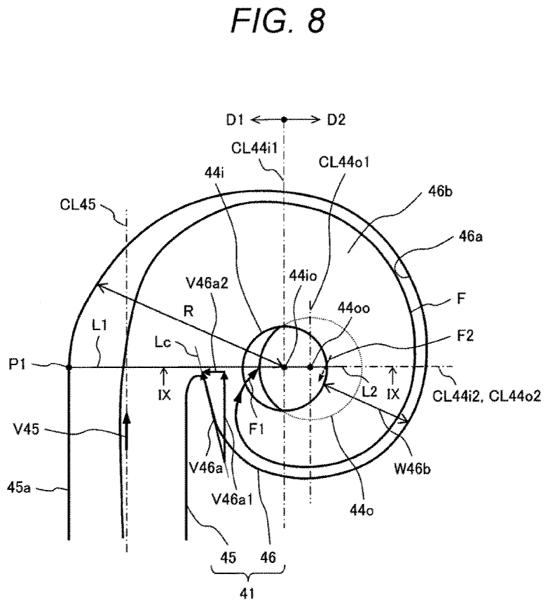

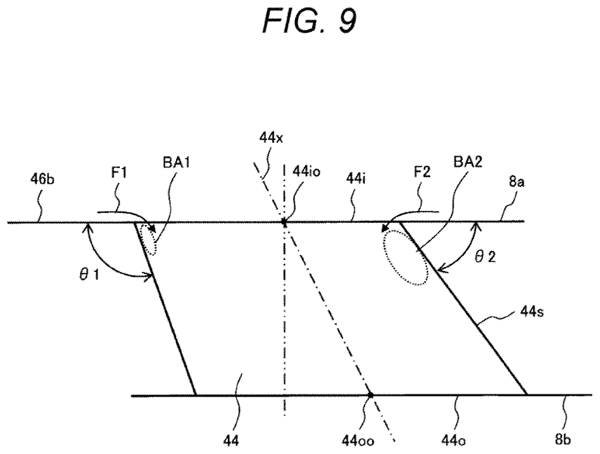

The two swirl passages 41 on the left side inject sprays directed to the left on the paper surface of FIG. 7, and the two swirl passages 41 on the right side inject sprays directed to the right. In the two swirl passages 41 on the left side, a center 4400 (see FIG. 8) of the injection hole outlet 44o is arranged at a position shifted leftward from the center 44io (see FIG. 8) of the injection hole inlet 44i. On the other hand, in the two swirl passages 41 on the right side, a center 4400 (see FIG. 8) of the injection hole outlet 44o is arranged at a position shifted rightward from the center 44io (see FIG. 8) of the injection hole inlet 44i.

In the two swirl passages 41 on the left side, the respective communication passages 45 extend in directions different by 180° (vertical direction in FIG. 7). In the two swirl passages 41 on the right side, the respective communication passages 45 extend in directions different by 180° (vertical direction in FIG. 7). The two swirl passages 41 on the left side and the two swirl passages 41 on the right side are arranged in a line-symmetric shape with respect to a straight line Ld passing through the axis 1x and extending in the vertical direction. Further, center lines CL45 of the respective communication passages 45 in the two swirl passages 41 on the left side are aligned on a straight line, and center lines CL45 of the respective communication passages 45 in the two swirl passages 41 on the right side are also aligned on a straight line. Further, the center lines CL45 of the communication passages 45 in the two swirl passages 41 on the left side are parallel to the center lines CL45 of the communication passage 45 in the two swirl passages 41 on the right side.

As the fuel injection hole 44, the communication passage 45, and the swirl imparting chamber 46 are arranged as illustrated in FIG. 7, a swirling velocity can be efficiently imparted to flow of fuel flowing from the communication passage 45 into the swirl imparting chamber 46. Further, the fuel flow imparted with the swirling velocity in the swirl imparting chamber 46 can flow into each of the fuel injection holes 44 (44i and 44o) inclined with respect to the axis 1x in the state of being suppressed from being separated from the inner peripheral surfaces of the fuel injection holes 44 (44i and 44o). The suppression of separation will be described in detail below.

The fuel flow in the swirl passage 41 will be described with reference to FIGS. 8 and 9. FIG. 8 is an enlarged plan view illustrating the vicinity of the swirl imparting chamber including a connection portion between the communication passage 45 and the swirl imparting chamber 46. FIG. 9 is a cross-sectional view illustrating a cross section parallel to the axis 44x of the fuel injection hole 44 and including the axis 44x. Incidentally, FIG. 8 is a projection view in which the fuel injection hole 44, the communication passage 45, and the swirl imparting chamber 46 are projected on a plane perpendicular to the axis 1x of the fuel injection valve 1, and a solid line indicates a configuration that appears on the proximal end surface 8a of the nozzle plate 8. Further, FIG. 9 is a cross section taken along line IX-IX of FIG. 8, and the cross section taken along line IX-IX is a cross section parallel to the axis 1x.

Hereinafter, a description will be given based on the projection view of FIG. 8.

In the present embodiment, a side wall 46a of the swirl imparting chamber 46 is formed in a spiral shape such as a spiral curve or an involute curve in FIG. 8. That is, the side wall 46a is formed in a spiral shape on the plane perpendicular to the axis 1x. A radius (a distance between a vortex center and the side wall 46a) R of the side wall 46a gradually decreases from the upstream side to the downstream side. For this reason, in a swirling flow path (flow path surface formed on the bottom surface 44b) formed around the injection hole inlet (inlet opening surface) 44i of the swirl imparting chamber 46, an area of a cross section perpendicular to the swirling direction and a flow path width W46b gradually decrease from the upstream side connected to the communication passage 45 to the downstream side.

In the present embodiment, center lines CL44il and CL44i2 passing through the center of the injection hole inlet 44i (in the present embodiment, coincident with the vortex center of the side wall 46a) 44io and center lines CL44o1 and CL44o2 passing through the center 4400 of the injection hole outlet 44o are drawn as illustrated in FIG. 8. The center line CL44i1 and the center line CL44o1 are center lines parallel to the center line CL45 of the communication passage 45. The center line CL44i2 and the center line CL44o2 are center lines perpendicular to the center line CL45 of the communication passage 45.

In the present embodiment, the vortex center of the side wall 46a of the swirl imparting chamber 46 coincides with the center 44io of the injection hole inlet 44i, but may be provided at a position shifted from the center 44io of the injection hole inlet 44i. The side wall 46a is formed such that a center angle of the side wall 46a about the vortex center is in the range of about 360°. For this reason, when a tangent Lc tangential to the side wall 46a is drawn, the tangent Lc has a direction vector V46a. Incidentally, a direction of the direction vector V46a is a direction from the upstream side to the downstream side. The direction vector V46a of the tangent Lc is decomposed into a first direction component V46a1 and a second direction component V46a2. The first direction component V46a1 is a component parallel to the center line CL45 of the communication passage 45. That is, the direction vector V46a of the tangent Lc has the direction component parallel to the center line CL45 of the communication passage 45. Further, the second direction component V46a2 is a component perpendicular to the center line CL45.

Fuel flowing through the communication passage 45 has a velocity component in a direction along the center line CL45 (the velocity component indicated by a direction vector V45). A direction of the direction vector V45 is a direction from the upstream side to the downstream side. Fuel flowing through the swirl imparting chamber 46 has a velocity component in a direction indicated by the first direction vector component V46a1 on the downstream side of the swirl flow path.

A second straight line L1 is a straight line with the maximum length from the center 44io of the injection hole inlet 44i to the side wall 46a of the swirl imparting chamber 46. One end of the second straight line L1 is at the center 44io of the injection hole inlet 44i, and the other end is at an intersection P1 with the side wall 46a. The intersection P1 is located at an upstream end portion (starting end portion) of the side wall 46a, and the side wall 46a of the swirl imparting chamber 46 and a side wall 45a of the communication passage 45 are connected at the intersection P1. In the present embodiment, the second straight line L1 overlaps the center line CL44i2 and the center line CL44o2.

The fuel injection holes 44 are formed as fuel injection holes inclined with respect to the axis 1x of the fuel injection valve such that the center 4400 of the injection hole outlet 44o is located on a side opposite to a side of the intersection P1 with the center line CL44i1 as a boundary. This means that the center 4400 of the injection hole outlet 44o is located on the side opposite to the intersection P1 with respect to the center 44io of the injection hole inlet 44i. Further, when the swirl imparting chamber 46 is divided into two regions D1 and D2 by a center line CL44i1 (a straight line parallel to the center line CL45 of the communication passage 45: a first straight line), the center 4400 of the injection hole outlet 44o is located on a side of the region (second region) D2 opposite to the region (first region) D1 to which the communication passage 45 is connected.

That is, when the straight line (second straight line) L1 with the maximum length from the center 44io of the inlet opening surface 44i to the side wall 46a is drawn, the intersection P1 between the straight line L1 and the side wall 46a is arranged in the first region D1, and the center 4400 of the outlet opening surface 44o is arranged on a straight line (third straight line) L2 obtained by extending the straight line L1 beyond the center 44io of the inlet opening surface 44i to the side opposite to the side where the intersection P1 is located.

Flow of fuel flowing from the communication passage 45 into the swirl imparting chamber 46 flows along the side wall 46a as illustrated by an arrow F in FIG. 8, and is imparted with a swirling velocity. Most of the fuel that has flowed so as to be pressed against the side wall 46a by the centrifugal force flows into the fuel injection hole 44 on the downstream side (region D1 side) of the swirl flow path. The flow flowing into the fuel injection hole 44 is indicated by an arrow F1. On the other hand, flow of fuel flowing into the fuel injection hole 44 in an intermediate portion of the swirl flow path is indicated by an arrow F2. The flow of fuel flowing into the fuel injection hole 44 in the intermediate portion of the swirl flow path is not so much as compared with the flow of fuel flowing into the fuel injection hole 44 on the downstream side (region D1 side) of the swirl flow path. That is, the main flow of the fuel flow flows into the fuel injection holes 44 as indicated by the arrows F and F1.

Since the center 44io of the injection hole inlet 44i and the center 4400 of the injection hole outlet 44o are arranged as described above in the present embodiment, an angle (inlet angle of the fuel injection hole 44) formed between the side surface (inner peripheral surface) 44s of the fuel injection hole 44, which is the truncated cone, and the bottom surface 46b of the swirl imparting chamber is an angle such as θ1 and θ2 in FIG. 9. The angle θ1 is an inlet angle (first inlet angle) on the region D1 side, and is the inlet angle formed on a line segment connecting the center 44io and the intersection P1 in the present embodiment. The angle θ2 is an inlet angle (second inlet angle) on the region D2 side, and is the inlet angle formed on an extension obtained by extending the straight line L1 beyond the center 44io to the region D2 side in the present embodiment.

The inlet angle (first inlet angle) θ1 on the straight line L1 side is larger than 90 degrees, and the inlet angle (second inlet angle) θ2 on the extension side is smaller than 90 degrees. Further, the sum of θ1 and θ2 is configured to be smaller than 180 degrees since the fuel injection hole 44 has the shape whose diameter increases from the upstream side to the downstream side. Here, θ1 is the maximum value of the inlet angle, and θ2 is the minimum value of the inlet angle. Therefore, the maximum value θ1 of the inlet angle is larger than 90 degrees, the inlet angle θ2 is smaller than 90 degrees, and the sum of the maximum value θ1 and the minimum value θ2 is smaller than 180 degrees, in the present embodiment. Incidentally, the maximum value θ1 and the minimum value θ2 of the inlet angle are set at positions spaced apart in the circumferential direction of the injection hole inlet 44i, the positions opposing each other (on the opposite sides) with the center 44io of the injection hole inlet 44i interposed therebetween.

A region BA1 separated from the inner peripheral surface 44s of the fuel injection hole 44 can be reduced in the fuel flow F1 flowing into the fuel injection hole 44 in a portion with the inlet angle θ1 or the vicinity thereof. On the other hand, a region BA2 separated from the inner peripheral surface 44s of the fuel injection hole 44 becomes large in the fuel flow F2 flowing into the fuel injection hole 44 in a portion with the inlet angle θ2 or the vicinity thereof. In the present embodiment, the main flow of the fuel flowing through the swirl imparting chamber 46 is the fuel flow F1, and thus, the separation region of the fuel injection hole 44 from the inner peripheral surface 44s can be reduced.

In the present embodiment, the axis 44x of the fuel injection hole 44 passing through the center 44io of the injection hole inlet 44i and the center 4400 of the injection hole outlet 44o overlaps the center line CL44i2 and the center line CL44o2, and is aligned with the straight line L1 on the same straight line in FIG. 8. In the present embodiment, the side wall 46a has the center angle formed in the range of about 360°, and thus, the separation region of the main fuel flow flowing through the swirl imparting chamber 46 from the inner peripheral surface 44s of the fuel injection hole 44 can be reduced with such an arrangement.

When the configuration and the fuel flow described with reference to FIGS. 7 to 9 are summarized, the present embodiment has the following configuration.

The four sets of swirl passages 41 are provided on the nozzle plate 8. When the nozzle plate 8 is divided into a third region D3 and a fourth region D4 by a straight line (a fourth straight line) Ld intersecting with the valve axis 1x, two sets of swirl passages 41 among the four sets of swirl passages 41 are arranged in the third region D3, and the other two sets of swirl passages 41 are arranged in the fourth region D4.

In the two sets of swirl passages 41 arranged in the third region D3, the respective communication passages 45 extend in directions different by 180°. In the two sets of swirl passages 41 arranged in the fourth region D4, the respective communication passages extend in directions different by 180°.

The two sets of swirl passages 41 arranged in the third region D3 and the two sets of swirl passages 41 arranged in the fourth region D4 are configured such that center lines CL45 of the communication passages 45 are mutually parallel, and the first region D1 of the swirl imparting chamber 46 is arranged to be closer to the fourth straight line Ld than the second region D2.

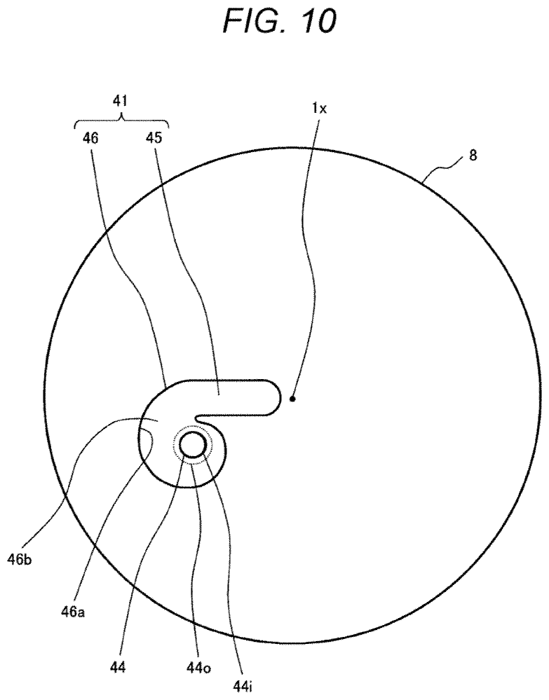

FIG. 10 is a view illustrating a modification of the nozzle plate 8 of the fuel injection valve 1, and is a plan view as viewed from one end side (upstream side) in the direction of the axis 1x.

As illustrated in FIG. 10, a configuration without the central chamber 42 may be adopted. In this case, in a configuration in which a plurality of swirl passages 41 are provided, each of the swirl passages 41 is independent and does not communicate with each other via the central chamber 42. An upstream end of the swirl passage 41 directly communicate with the downstream opening portion 48 of the valve seat member 7.

With the above-described configuration, it is possible to form sprays in two directions with a smaller spray angle by suppressing the spread of the spray by weakening a swirl force in the present embodiment. Further, a liquid film can be made thin, and thus, atomization of the spray can be improved. Further, a thin and stable liquid film in the fuel injection hole 44 can be formed by decreasing a separation region, and thus, the atomization of the spray can be further improved.

Incidentally, the present invention is not limited to the respective embodiments described above, and includes various modifications. For example, the above-described embodiments have been described in detail in order to describe the present invention in an easily understandable manner, and are not necessarily limited to one including the entire configuration thereof. Further, some configurations of a certain embodiment can be substituted by configurations of another embodiment, and further, a configuration of another embodiment can be also added to a configuration of a certain embodiment. Further, addition, deletion or substitution of other configurations can be made with respect to some configurations of each working example.

### REFERENCE SIGNS LIST

1x axis of fuel injection valve 1
8 nozzle plate
41 swirl passage
42 central chamber
44 fuel injection hole
44i injection hole inlet (upstream end)
44o injection hole outlet (downstream end)
44s inner peripheral surface of fuel injection hole 44
44x axis of fuel injection hole 44
45 communication passage (lateral passage)
46 swirl imparting chamber
46a side wall of swirl imparting chamber 46
46b bottom (bottom surface) of swirl imparting chamber 46
CL44i1, CL44i2 center line passing through center 44io of injection hole inlet 44i
CL44o1, CL44o2 center line passing through center 4400 of injection hole outlet 44o CL45 center line of communication passage 45
D1 One region when swirl imparting chamber 46 is divided into two regions by center line CL44i1
D2 Other region when swirl imparting chamber 46 is divided into two regions by center line CL44i1
D3 One region (third region) obtained by dividing nozzle plate 8 by straight line (fourth straight line) Ld intersecting with valve axis 1x
D4 Other region (fourth region) obtained by dividing nozzle plate 8 by straight line (fourth straight line) Ld intersecting with valve axis 1x
L1 straight line with maximum length from center 44io of injection hole inlet 44i to side wall 46a of swirl imparting chamber 46
Lc tangent to side wall 46a
P1 intersection between straight line L1 and side wall 46a
V46a direction vector of tangent Lc
V46a1 first direction component of direction vector V46a
V46a2 second direction component of direction vector V46a
θ1 inlet angle formed on line segment connecting center 44io and intersection P1
θ2 inlet angle formed on extension of straight line L1 extending toward region D2 beyond center 44io.

1. A fuel injection valve comprising:
a valve body and a valve seat that cooperate to open and close a fuel passage;
a swirl imparting chamber that is arranged on a downstream side of an opening and closing portion of the fuel passage by the valve body and the valve seat, and imparts a swirling velocity to fuel;
a communication passage arranged on an upstream side of the swirl imparting chamber and connected to the swirl imparting chamber; and
a fuel injection hole that is open at a bottom surface of the swirl imparting chamber and injects fuel imparted with the swirling velocity in the swirl imparting chamber to an outside,
wherein the fuel injection hole is configured such that a cross-sectional area of the fuel injection hole increases from an inlet side to an outlet side.

2. The fuel injection valve according to claim 1, wherein a hole axis of the fuel injection hole is inclined with respect to a valve axis of the fuel injection valve.

3. The fuel injection valve according to claim 2, wherein a maximum value of an inlet angle formed between a side surface of the fuel injection hole and the bottom surface of the swirl imparting chamber is larger than 90 degrees, a minimum value of the inlet angle is smaller than 90 degrees, and a sum of the maximum value and the minimum value is smaller than 180 degrees.

4. The fuel injection valve according to claim 3, wherein when the swirl imparting chamber is divided into a first region and a second region by a first straight line passing through a center of an inlet opening surface of the fuel injection hole,
in a projection view in which the swirl imparting chamber, the communication passage, and the fuel injection hole are projected on a plane perpendicular to the valve axis,
the communication passage is connected to the first region, and
a center of an outlet opening surface of the fuel injection hole is located in the second region.

5. The fuel injection valve according to claim 4, wherein
the communication passage has a straight center line, and
the first straight line is a straight line parallel to the center line of the communication passage.

6. The fuel injection valve according to claim 5, wherein a side wall of the swirl imparting chamber is formed in a spiral shape.

7. The fuel injection valve according to claim 6, wherein a direction vector of a tangent has a direction component parallel to the center line of the communication passage when the tangent that is tangential to the side wall is drawn.

8. The fuel injection valve according to claim 7, wherein when a second straight line with a maximum length from the center of the inlet opening surface to the side wall is drawn,
an intersection of the second straight line and the side wall is arranged in the first region, and
the center of the outlet opening surface is arranged on a third straight line, obtained by extending the second straight line beyond the center of the inlet opening surface to a side opposite to a side where the intersection is located.

9. The fuel injection valve according to claim 7, further comprising a nozzle plate having swirl passages constituted by the swirl imparting chamber and the fuel injection hole,
wherein four sets of the swirl passages are provided on the nozzle plate, and
when the nozzle plate is divided into a third region and a fourth region by a fourth straight line intersecting with the valve axis,
two sets of swirl passages among the four sets of swirl passages are arranged in the third region, and other two sets of swirl passages are arranged in the fourth region,
the two sets of swirl passages arranged in the third region have communication passage respectively extending in directions different by 180°,
the two sets of swirl passages arranged in the fourth region have communication passages respectively extending in directions different by 180°, and
the two sets of swirl passages arranged in the third region and the two sets of swirl passages arranged in the fourth region are configured such that center lines of the communication passages are mutually parallel, and the first region of the swirl imparting chamber is arranged on a side closer to the fourth straight line with respect to the second region.

10. The fuel injection valve according to claim 9, wherein the two sets of swirl passages arranged in the third region and the two sets of swirl passages arranged in the fourth region are configured to have a line-symmetric shape with respect to the fourth straight line.
